(19) United States
(12) Patent Application Publication
(10) Pub. No.: US 2026/0038196 A1
(43) Pub. Date: Feb. 5, 2026

(54) METHOD OF GEOMETRY PROCESSING FOR OBJECT-SPACE SHADING AND RENDERING APPARATUS

(71) Applicant: Huawei Cloud Computing Technologies Co., Ltd., Gui'an New District (CN)

(72) Inventors: Joerg Mueller, Zurich (CH); Martin Winter, Munich (DE); Karl Haubenwallner, Munich (DE); Markus Steinberger, Munich (DE)

(73) Assignee: Huawei Cloud Computing Technologies Co., Ltd., Gui'an New District (CN)

(21) Appl. No.: 19/353,538

(22) Filed: Oct. 8, 2025

Related U.S. Application Data
(63) Continuation of application No. PCT/EP2023/072101, filed on Aug. 9, 2023.

(51) Int. Cl. G06T 15/80; G06T 15/00; G06T 15/04; G06T 15/06

(52) U.S. Cl. CPC G06T 15/80; G06T 15/005; G06T 15/04; G06T 15/06

(57) ABSTRACT

To provide efficient triangle index mapping for an object-space shading, a geometry processing includes splitting UV coordinate data of an object to be shaded into UV layers so that each UV layer comprises non-overlapping triangles with coordinates within a 0-1 range, and generating triangle index, ID, information for the UV layers to be used for the object-space shading with a ray tracing of triangle IDs for sample points in the UV layers. As a result, a unique texture space with non-overlapping triangles within the 0-1 range is provided to store texture-space shading. A rendering apparatus configured for such geometry processing is beneficial to provide an efficient solution for building an object-space shading framework.

### CROSS-REFERENCE TO RELATED APPLICATIONS

This application is a continuation of International Application No. PCT/EP2023/072101, filed on Aug. 9, 2023, the disclosure of which is hereby incorporated by reference in its entirety.

### TECHNICAL FIELD

The present disclosure relates generally to the field of computer graphics and, more specifically, to a method of geometry processing for object-space shading and a rendering apparatus.

### BACKGROUND

Typically, in the field of computer graphics, shading methods are used for performing rendering computations in a space. In such shading methods, the shading can be performed in a per-object local space, which is temporally stable and can handle disocclusion of samples that are occluded in other spaces. In case of working in the per-object local space, the shading methods can work in a texture space, which corresponds to a two-dimensional space and involves the mapping of two-dimensional images onto three-dimensional objects. However, the problem with the shading methods is that such methods have difficulties in mapping between texture-space coordinates and corresponding identifiers of the object's geometry such as triangles and thereby compute the mapping at a pre-processing step. Further, such pre-computer mapping of the texture-space coordinates into the identifiers consumes a lot of memory, which is not desirable. Further, during rasterization, only small blocks of pixels of the image are rasterized to save memory which entails rasterizing more triangles than pixels, that is, most triangles are discarded, which results in wasted computations.

Currently, certain attempts have been made to solve the problem of mapping between the texture-space coordinates and the identifiers that consists of processing overlapping triangles and/or triangles with out-of-bounds coordinates. Such attempts include the use of custom texture space coordinates, which provide an additional U-V channel and are considered during rendering, reading, or writing to textures, which store shading data. However, the problem associated with the custom texture space coordinates is that the creation of the custom texture space coordinates requires an algorithm, which balances the distortion of the triangles in a space with the number of seams that need to be introduced. Furthermore, such attempts are difficult to implement, and do not generate a desired output, such as due to the need of large amount of memory space is needed, which affects the performance of a rendering hardware, and is not desirable. Multiple resolutions are rendered, which increases the amount of memory needed for the conventional shading methods. Thus, there exists a technical problem of how to provide a texture space with non-overlapping triangles within a given range in order to have a unique address space to store the shading, as well as generating identifiers, which need to be available during run-time for corresponding texture space.

Therefore, in light of the foregoing discussion, there exists a need to overcome the aforementioned drawbacks associated with conventional shading computation techniques.

### SUMMARY

The present disclosure provides a method of geometry processing for an object-space shading and a rendering apparatus configured for geometry processing for the object-space shading. The present disclosure provides a solution to the existing problem of how to provide a texture space with non-overlapping triangles within a given range in order to have a unique address space to store the shading, as well as generating identifiers, which need to be available during run-time for corresponding texture space. An aim of the present disclosure is to provide a solution that overcomes at least partially the problems encountered in the prior art and provides an improved method of geometry processing for the object-space shading and an improved rendering apparatus configured for geometry processing for the object-space shading, such as ray-traced triangle IDs for the object-space shading.

One or more objectives of the present disclosure are achieved by the solutions provided in the enclosed independent claims. Advantageous implementations of the present disclosure are further defined in the dependent claims.

In one aspect, the present disclosure provides a method of geometry processing for an object-space shading, the method comprising: splitting UV coordinate data of an object to be shaded into UV layers so that each UV layer comprises non-overlapping triangles with coordinates within a 0-1 range, and generating triangle index, ID, information for the UV layers to be used for the object-space shading.

The method provides for adapting the original artist-provided UV coordinates of an object, including UV coordinates of overlapping triangles and out-of-bounds UV coordinates, by splitting the existing texture space into UV layers, instead of generating a novel generic texture space, which is not tuned for the original model. As a result, only a single UV-channel is required for both the texture access and the texture-space shading. The method is thereby beneficial to replace the novel texture-space generation with a pre-processing step, which adapts the artist-provided UV-coordinates to UV layers comprising non-overlapping triangles with coordinates within a 0-1 range. Furthermore, the triangle ID information generated for such UV layers can be ray-traced instead of rasterized and the ray tracing can be either performed as a separate step before the object-space shading stage or on-demand during object-space shading.

In an implementation form, the splitting of the UV coordinate data into UV coordinate layers comprises: splitting each triangle with one or more coordinates outside the 0-1 range from the UV coordinate data into smaller triangles with coordinates within the 0-1 range assigned to different UV layers, and splitting overlapping triangles into different UV layers, wherein the split triangles are assigned to as few UV layers as possible.

In further implementation form, the splitting of each triangle with one or more coordinates outside the 0-1 range from the UV coordinate data into smaller triangles comprises: splitting the triangle with coordinates that differ in an integer component into smaller triangles along axis-aligned lines at integer intervals of the coordinates so that all the split triangles have a uniform integer component, and setting all non-zero integer components of the coordinates of the split triangles to zero.

In another implementation form, the splitting of overlapping triangles into different UV layers comprises: defining one or more islands of triangles, wherein each island comprises neighbouring triangles that share one or more UV vertices, splitting islands into unit islands along axis-aligned lines at integer intervals of the coordinates, splitting each unit island that comprises overlapping triangles into as few islands without overlapping triangles as possible, and splitting overlapping islands into as few groups of islands without overlaps as possible, wherein each group of islands without overlaps is assigned to a different UV layer.

In further implementation form, the splitting of each unit island that comprises overlapping triangles into as few islands without overlapping triangles as possible and the splitting of overlapping islands into as few groups of islands without overlaps as possible comprise solving a graph colouring problem approximately with a greedy algorithm. In such implementation forms, the method provides for effective splitting of UV coordinate data of triangles with out-of-bounds coordinates as well as overlapping triangles into as few UV layers as possible so that to reduce the overhead during object space shading at run-time caused by additional island borders introduced by any unnecessary splittings.

In yet another implementation form, the generating of triangle ID information for the UV layers comprises two-dimensional ray tracing of triangle indices, IDs, for sample points in the UV layers.

Beneficially, instead of relying on inflexible results permitted by rasterization, the method provides for utilizing the two-dimensional ray tracing of the triangle IDs, not only severely reducing the memory overhead but also increasing flexibility, as the triangle ID information can now also be queried on-demand.

In another implementation form, the two-dimensional ray tracing of triangle IDs comprises using a quad tree-based acceleration structure.

In yet another implementation form, the method further comprises assigning empty areas at the borders of the object geometry in the UV layers to triangles located therein.

In further implementation form, the assigning of empty areas comprises building a straight skeleton in each UV layer by means of determining borders of the 0-1 range as non-moving edges, building the straight skeleton by moving the outer edges of a polygon composed of the triangles located in the UV layer, generating additional triangles by triangulating areas swept by the moving edges, and assigning each of the additional triangles to that triangle whose moving edge was swept over the corresponding area.

The straight skeleton-based border handling is beneficial to provide improved results with more accurate borders.

In another implementation form, the generating of triangle ID information for the UV layers comprises three-dimensional ray tracing of triangle indices, IDs, for sample points in the UV layers, and the method comprises assigning empty areas at borders of the object geometry in the UV layers to triangles located therein by means of building simple skirts in each UV layer by extending three-dimensional skirts as wavefronts from outer edges of a polygon composed of the triangles located in the UV layer.

The approximation to correct triangle ID computation by means of building simple skirts, on one hand requires the three-dimensional ray tracing, but on the other hand it is a fair trade-of, since it is much easier to compute and the errors introduced by it increase with distance from the originating edge and thus should hardly cause noticeable issues in a texture-space rendering system.

In an implementation form, the ray tracing of triangle IDs is conducted during a pre-processing stage of the object-space shading for all the sample points in the UV layers and the method comprises: mapping the ray-traced triangle IDs into textures with a multum in parvo, MIP, hierarchy, and storing the textures into a storage medium for loading it during a run-time of the object-space shading.

In another implementation form, the ray tracing of triangle IDs is conducted during a run-time of the object-space shading for a limited number of sample points in the UV layers that have been determined as visible.

In yet another implementation form, the ray tracing of triangle IDs is conducted during a run-time of the object-space shading for a limited number of sample points in the UV layers, when it is required for computing graphics effects in a texture space of the object.

The method thereby provides for on-demand ray tracing of the triangle IDs, which reduces memory consumption both on disk, a random-access memory, RAM, and on a graphical processing unit, GPU, RAM and increases the flexibility of object-space rendering. Furthermore, the on-demand ray tracing of triangle IDs is resolution independent, resulting in improved quality via pre-rendered solutions at specific resolutions.

In another aspect, the present disclosure provides a rendering apparatus configured for geometry processing for an object-space shading in accordance with any of the implementation forms of the method described above.

The rendering apparatus achieves all the advantages and technical effects of the method of the present disclosure.

It is to be appreciated that all the aforementioned implementation forms can be combined. It is be noted that all devices, elements, circuitry, units, and means described in the present application could be implemented in the software or hardware elements or any kind of combination thereof. All steps which are performed by the various entities described in the present application, as well as the functionalities described to be performed by the various entities, are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flow chart of a method of geometry processing for an object-space shading, in accordance with an embodiment of the present disclosure;

FIG. 2 is a block diagram that depicts a rendering apparatus configured for geometry processing for an object-space shading, in accordance with different embodiments of the present disclosure;

FIG. 3 is a diagram that schematically depicts an object-space shading framework including the geometry processing in accordance with embodiments of the present disclosure;

FIG. 4 is a diagram that schematically depicts a scenario of UV space adaptation, in accordance with embodiments of the present disclosure;

FIG. 5 is a diagram that depicts a flowchart of a method of geometry processing for generating UV layers that can be implemented by a rendering apparatus, in accordance with an embodiment of the present disclosure;

FIG. 6 is a diagram that depicts a special case of degenerate triangle that can be handled during the geometry processing in accordance with an embodiment of the present disclosure;

FIG. 7 is a diagram that depicts a two-dimensional ray tracing of triangle IDs during the geometry processing in accordance with an embodiment of the present disclosure;

FIG. 8 is a diagram that depicts a quad-tree-based acceleration structure as used during the geometry processing in accordance with an embodiment of the present disclosure; and

FIG. 9 is a diagram that depicts an exemplary implementation of a straight skeleton building to assign empty areas at borders of an object geometry in a UV layer to triangles located therein in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

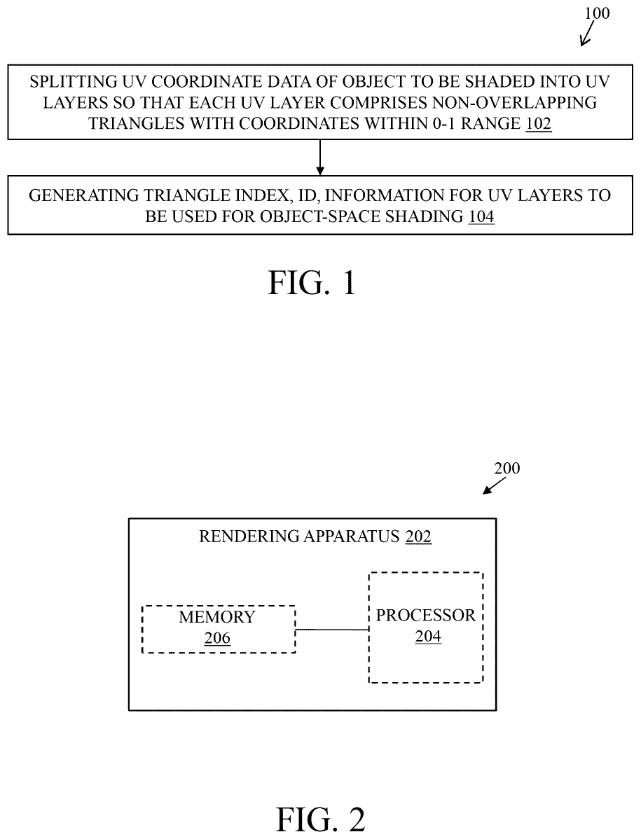

FIG. 1 is a flow chart of a method of geometry processing for an object-space shading, in accordance with an embodiment of the present disclosure. With reference to FIG. 1, there is shown a flow chart of a method 100 of geometry processing for an object-space shading. The method 100 includes the most important steps 102 and 104 of geometry processing that can be used in any object-space shading technique.

The method 100 provides an efficient solution for geometry processing for the object-space shading. In an implementation form, the texture may also be referred to as a texture space, which is a two-dimensional space where coordinates are usually normalized between 0 and 1 to the width/height of an image, so that the texture is independent of the image's resolution. Similar to typical X-coordinate, Y-coordinate, and Z-coordinate in 3D space, the coordinates in the texture are given the letters U and V, due to which texture coordinates and UV coordinates, or texture space and UV space are terms used interchangeably. In addition, the object-space shading is a process used to perform rendering computations in an object space, wherein the object space refers to any space that is local to an object. One such object space is the texture space, which is a space mapping the surface of the object. In contrast, a world space is a global space for all objects. While there is only a single world space, there is a different object space for each object. In an implementation form, the geometry processing for the object-space shading according to the method 100 can be realized by a rendering apparatus.

At step 102, the method comprises splitting UV coordinate data of an object to be shaded into UV layers so that each UV layer includes non-overlapping triangles with coordinates within a 0-1 range. Thereby, the method 100 provides UV layers with non-overlapping triangles within the 0-1 range to have a unique address space to store texture-space shading data. The UV layers with coordinates of non-overlapping triangles within the 0-1 range are provided with the present method as a unique texture space for each object by splitting the existing artist-provided texture space, instead of generating a custom UV-space for each object, that conventionally leads to a plurality of additional UV channels generated from the artist-provided geometry to fit the criteria of non-overlapping geometry and staying within 0-1 range to be considered during rendering when reading or writing to the texture, which stores data related to the object-space shading. The adaptation of the artist-provided UV-coordinates into a single UV channel both for texture access and the object-space shading in the present disclosure reduces memory consumption and enables the use of improved-quality UV-coordinates as provided by the artist instead of requiring the generation of novel, custom sets of UV-channels in the prior art solutions.

In an embodiment, the splitting of the UV coordinate data into UV coordinate layers in the method 100 includes splitting each triangle with one or more coordinates outside the 0-1 range from the UV coordinate data into smaller triangles with coordinates within the 0-1 range assigned to different UV layers and splitting overlapping triangles into different UV layers, wherein the split triangles is assigned to as few UV layers as possible. In an implementation form of such embodiment, the splitting of each triangle with one or more coordinates outside the 0-1 range from the UV coordinate data into smaller triangles in the method 100 comprises splitting the triangle with coordinates that differ in an integer component into smaller triangles along axis-aligned lines at integer intervals of the coordinates so that all the split triangles have a uniform integer component, and setting all non-zero integer components of the coordinates of the split triangles to zero. In other words, in order to adapt triangles with coordinates outside the 0-1 range, the integer component and the decimal component of the UV-coordinates are considered separately, such that any triangles with the UV-coordinates that differ in the integer component are subdivided into smaller triangles along axis-aligned lines at integer intervals, so that all the split triangles have a uniform integer component. Thereafter, all the non-zero integer components are set to zero to bring the UV coordinates into the 0-1 range. Such adaptation does not change the sampling of the texture, if the sampling address mode is repeating. Optionally, the method 100 can be trivially adapted for other sampling address modes, such as mirrored repeating.

In another implementation form of such embodiment, the splitting of overlapping triangles into different UV layers in the method 100 comprises defining one or more islands of triangles, wherein each island includes neighbouring triangles that share one or more UV vertices, splitting islands into unit islands along axis-aligned lines at integer intervals of the coordinates, splitting each unit island that includes overlapping triangles into as few islands without overlapping triangles as possible, and splitting overlapping islands into as few groups of islands without overlaps as possible, wherein each group of islands without overlaps is assigned to a different UV layer.

Thereby the method 100 ensures the use of the least amount of the space and memory, while at the same time not unnecessarily splitting the islands. Beneficially, as compared to conventional techniques, the method 100 provides an improved performance, as splitting the islands in each case introduces additional borders, which then increases the overhead when filtering at borders.

In a further embodiment, the splitting of each unit island that includes overlapping triangles into as few islands without overlapping triangles as possible and the splitting of overlapping islands into as few groups of islands without overlaps as possible include solving a graph colouring problem approximately with a greedy algorithm. Indeed, the minimization of the resulting number of islands and the resulting number of groups of islands which corresponds to an NP-hard graph colouring problem and thus can be solved approximately with various greedy algorithms.

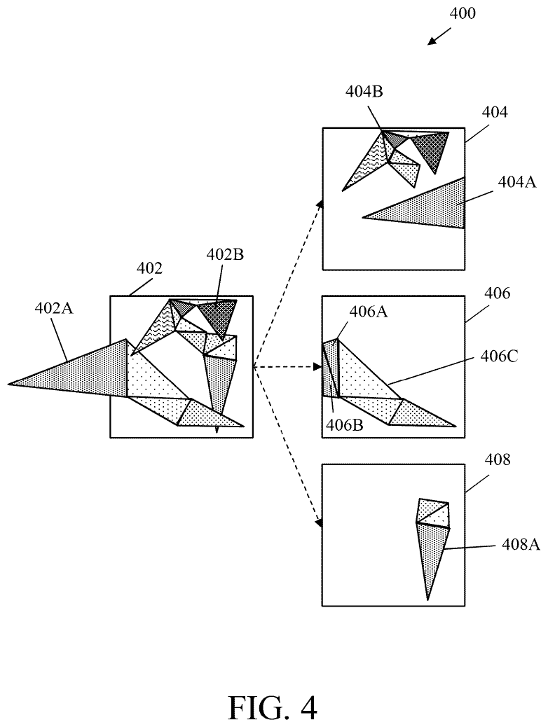

An exemplary implementation of defining islands of triangles and splitting the same into UV layers is further shown and described with reference to FIG. 4.

At step 104, the method comprises generating triangle index, ID, information for the UV layers to be used for the object-space shading. Thereby, the triangle ID information becomes available for the UV layers during the run-time and thereby it is not required to pre-render the triangle ID information during the pre-processing. This allows avoiding essential problems of the prior art solutions where the triangle ID information is pre-rendered, either at the pre-processing step or during run-time for newly visible geometry in a scene. Indeed, in the case of rendering during the pre-processing step, the textures are stored on a disk and can be uploaded to a graphics processing unit (GPU) during the run-time as needed. Alternatively, in the case of rendering during the run-time, additional disk memory is not required, but the additional run-time cost is incurred. In both cases, border handling needs to be considered in the prior art solutions, typically by means of some form of dilation filter, cither using a modified version of conservative rasterization or a pixel filtering technique. By virtue of generating the triangle ID information for the UV layers, the method 100 is beneficial to solve essential problems of the prior art solutions, which are inherent to the known texture-space shading techniques. The method 100 provides a unique texture space for each object as well as provides the triangle ID information for said unique texture space. Both steps (i.e., step 102 and 104) of the method 100 are necessary to provide unique sampling locations for the texture-space shading as well as for providing access to the necessary geometry information at such sampling locations through the triangle ID information.

In an embodiment, the generating of triangle ID information for the UV layers includes two-dimensional ray tracing of triangle indices, IDs, for sample points in the UV layers. Therefore, instead of relying on inflexible results permitted by rasterization, the method 100 provides for utilizing the two-dimensional ray tracing of the triangle IDs, which severely reduces the memory overhead and increases flexibility, as the triangle ID information can now also be queried on-demand. The generating of triangle ID information, which is also referred to as a triangle ID rendering, of the method 100 has two main differences to the conventional rendering techniques. At first, the UV coordinate data adaptation of the method 100 provides for conducting the triangle ID rendering in the two-dimensional space rather than in a three-dimensional space. Secondly, there is no overlapping geometry in the UV layers obtained with the method 100. The ray tracing procedure can be optimized, e.g. with the use of specialized hardware, based on said two differences. The most important optimization is based on that only two-dimensional rendering is necessary, which means that the third dimension can be dropped in comparison to a conventional three-dimensional ray-tracing hardware. This also means that there is actually no ray marching required, since there is no ray, but a single point that is sampled. Since the texture space with the UV layers obtained by the method 100 ensures the lack of overlaps, only a single triangle can lie at a certain position and no overlap resolution or ordering of triangles is required. An exemplary implementation of the two-dimensional ray tracing of triangle IDs is further shown and described with reference to FIG. 7.

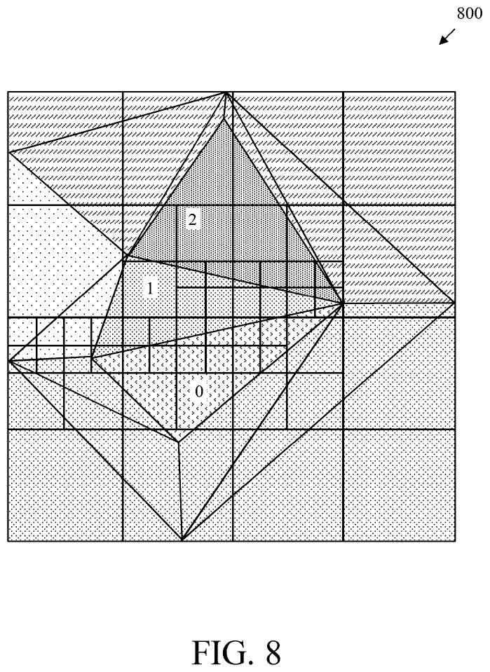

In an implementation form of such embodiment, the two-dimensional ray tracing of the triangle IDs includes using a quad tree-based acceleration structure. The method 100 in this implementation can also be beneficially used for providing on-demand ray tracing of the triangle IDs during run-time of the object-space shading. There are various options for tree-based acceleration structures that can be used in the two-dimensional ray-tracing. At that, the use of the quad tree-based acceleration structure, which is further shown and described with reference to FIG. 8, instead of a bounding volume hierarchy, BVH, allows achieving an enhanced performance. Since the triangle IDs are usually computed for pixel blocks with a power of two resolutions, the use of the quad tree-based acceleration structure leads to ideal coherence between the sample locations within a block allowing optimal utilization of parallelized hardware. In an implementation form, such specialized hardware can also be utilized to sample different two-dimensional, triangle-based data, such as vector-based texturing. Beneficially, as compared to conventional solutions, the on-demand ray tracing of the triangle IDs reduces memory consumption both on disk, RAM as well as on GPU RAM and increases the flexibility of the object-space rendering. Furthermore, the on-demand ray tracing of triangle IDs is resolution independent, resulting in an improved quality via pre-rendered solutions at specific resolutions.

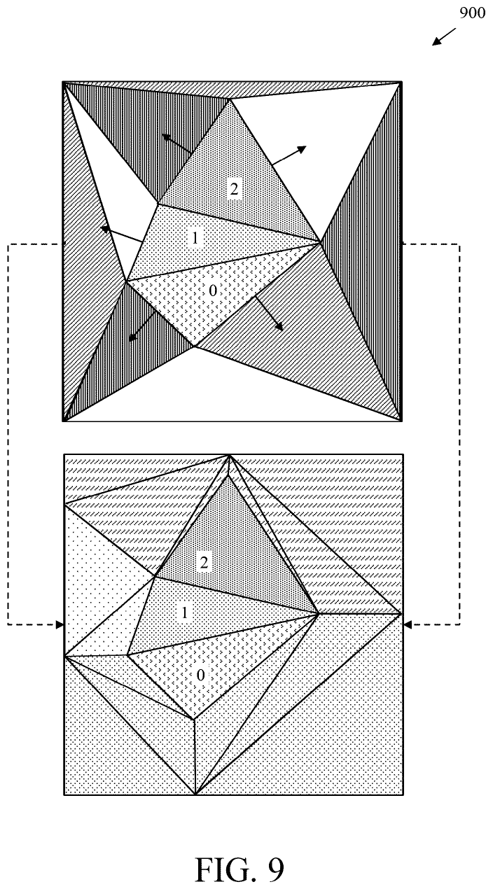

In an embodiment, the method 100 further comprises assigning empty areas at borders of the object geometry in the UV layers to triangles located therein. In further embodiment, the assigning of empty areas comprises building a straight skeleton in each UV layer by means of: determining borders of the 0-1 range as non-moving edges, building the straight skeleton by moving outer edges of a polygon composed of the triangles located in the UV layer, generating additional triangles by triangulating areas swept by the moving edges, and assigning each of the additional triangles to that triangle whose moving edge was swept over the corresponding area. Thereby, instead of tackling border issues by filtering already rendered pixels as it is done in the prior art solutions, the method 100 in this embodiment uses the straight skeleton that adds additional geometry to fill in the space that needs filtering, resulting in a resolution independent solution that replaces filtering and works in combination with the two-dimensional ray tracing. An exemplary implementation of building the straight skeleton (or using the straight skeleton algorithm) to fill the empty areas of the object geometry in one of the UV layers is further shown and described with reference to FIG. 9.

It is known that the straight skeleton is built by moving edges of a polygon, such as the one composed of triangles located in a UV layer, at the same speed, and assigning empty areas swept over by the edges to the corresponding border triangle. For achieving an enhanced performance, in the above-described embodiment the method 100 comprises using an improved straight skeleton algorithm of Aichholzer and Aurenhammer, which is further modified to support non-moving edges at the borders of the 0-1 range in the UV layer, generate a triangulation of the areas swept only by the moving edges and assign these triangles (obtained in result of the triangulation) to the respective original edge of the polygon, i.e. to the corresponding triangle which edge represents the original edge of the polygon. As a result, the two-dimensional ray tracing of the triangle IDs, such as for sample points in the UV layers, includes simple mapping from the ray-traced triangle to an original triangle. Beneficially, as compared to conventional solutions, the method 100 provides an improved border handling at any resolution without having to run any filtering, which in turn leads to a higher quality end result of the shading. Moreover, the straight-skeleton-based border handling of the method 100 can be advantageously used together with rasterized triangle IDs.

In another embodiment, the generating of the triangle ID information for the UV layers comprises three-dimensional ray tracing of triangle indices, IDs, for sample points in the UV layers, and in this case the method 100 further comprises assigning empty areas at borders of the object geometry in the UV layers to triangles located therein by means of building simple skirts in each UV layer by extending three-dimensional skirts as wavefronts from the outer edges of a polygon composed of the triangles located in the UV layer. This embodiment is alternative to the straight-skeleton-based border handling described above and it can be beneficial as straight skeletons are not easy to compute and prone to floating point inaccuracies. With this embodiment the method 100 provides an approximation to correct the triangle ID computation using simple skirts that are extended from the outer edges of the polygon of triangles located in a UV layer and that represent the wavefronts. The building of such simple skirts allows to avoid handling any of the undesired events of the straight-skeleton-based border handling. Such simple skirts will necessarily overlap and thus need to be three-dimensional in order to still produce a resulting geometry that can be used for ray-tracing of the triangle IDs. As a result, this embodiment of the method 100 is a fair trade-off, since the simple skirts arc much easier to compute while errors introduced by them increase with a distance from an originating edge and thus do not cause noticeable issues in a texture-space rendering apparatus.

In an embodiment, the ray tracing of triangle IDs is conducted during a pre-processing stage of the object-space shading for all the sample points in the UV layers, and in this case the method 100 further comprises mapping the ray-traced triangle IDs into textures with a multum in parvo, MIP, hierarchy, and storing the textures into a storage medium for loading it during a run-time of the object-space shading. This embodiment reflects that the ray tracing of the triangle IDs can occur at various stages of the object-space shading which includes the ray tracing of the triangle IDs during the pre-processing step. In this case, the triangle IDs are mapped and rendered into the textures (e.g., dense textures) with the MIP hierarchy (i.e., a full MIP hierarchy) and stored on the storage medium (e.g., a disk), so that during the run-time, the triangle IDs are loaded into the GPU memory when the respective object is rendered.

In another embodiment, the ray tracing of triangle IDs is conducted during a run-time of the object-space shading for a limited number of sample points in the UV layers that have been determined as visible. In other words, this embodiment is an alternative to the previous one and reflects the case of conducting the ray tracing of triangle IDs as a separate stage during the run-time of the object-space shading, such as for rendering the triangle ID textures on the fly (e.g., typically as 8×8 blocks). It is worth noting that this procedure can also be done with the conventional rasterization, though it would be less efficient and lead to a lot of clipping, i.e. cutting and removing triangles not within an 8×8 block.

In yet another embodiment, the ray tracing of triangle IDs is conducted during a run-time of the object-space shading for a limited number of sample points in the UV layers, when it is required for computing graphics effects in a texture space of the object. This embodiment is another alternative to the previous two ones and reflects the case of conducting the ray tracing of the triangle IDs on-demand, that is when the triangle IDs are needed for computing shading or various graphics effects in the texture space. The advantage of this embodiment is that less memory is used, though the triangle IDs are not cached in such instance. However, the ray tracing of the triangle IDs has a very low impact on the performance, especially when a purpose-built hardware is used.

The selective rendering of necessary triangle IDs in the latter two embodiments allows for an increased performance due to only necessary information for pixels, which are needed, is rendered in these cases, instead of rendering complete textures at the pre-processing stage.

The method 100 in all the embodiments and implementation forms described above provides an efficient solution for building an object-space shading framework. The method 100 provides a single texture space comprising non-overlapping triangles with coordinates within the 0-1 range in order to have a unique address space to store texture-space shading. Furthermore, the method 100 provides for generating triangle ID information for said texture space, which needs to be available for the object-space shading. The method 100 can be also used in other rendering algorithms that require a mapping from UV-coordinates in a two-dimensional vertex-data space to a corresponding closest geometry. The method 100 is beneficial to replace the generation of additional texture or UV channels with the adaptation of the artist-provided UV-coordinates at the pre-processing step. Furthermore, with the method 100 the triangle ID information is ray-traced instead of being rasterized and the ray-tracing can be either performed as a separate step before the object-space shading or on-demand during the object-space shading.

All the steps of the above-described embodiments and implementation forms of the method 100 are only illustrative, and other alternatives can also be provided where one or more steps are added, one or more steps are removed, or one or more steps are provided in a different sequence without departing from the scope of the present disclosure.

FIG. 2 is a block diagram that depicts a rendering apparatus configured for geometry processing for an object-space shading in accordance with different embodiments of the present disclosure. FIG. 2 is described in conjunction with elements from FIG. 1. With reference to FIG. 2 there is shown a block diagram 200 of a rendering apparatus 202 that is configured for geometry processing for an object-space shading.

In operation, the rendering apparatus 202 is configured for geometry processing for the object-space shading in accordance with any embodiment or implementation form of the method 100 described above with reference to FIG. 1. The rendering apparatus 202 is configured to split UV coordinate data of an object to be shaded into UV layers so that each UV layer includes non-overlapping triangles with coordinates within a 0-1 range. In an implementation form, the rendering apparatus 202 is configured to use some form of texture-space shading, such as on-surface caches, which include rendering engines, game engines, cloud rendering services, and the like.

The rendering apparatus 202 is thereby enabled to adapt the artist-provided UV coordinate data into a texture space of UV layers comprising non-overlapping triangles within the 0-1 range being a unique address space to store the texture-space shading data. The usage of the adapted artist-provided UV-coordinates as a single UV channel instead of generating additional UV channels reduces memory consumption, and enables achieving a higher-quality shading that accurately follows the geometry as provided by the artist.

The rendering apparatus 202 is further configured to generate a triangle index, ID, information for the UV layers to be used for the object-space shading. By virtue of generating the triangle ID information for the UV layers, the rendering apparatus 202 is beneficial to solve the essential problems inherent to the prior art texture-space shading solutions. The rendering apparatus 202 provides a proper texture space for each object without overlaps and out-of-bounds coordinates and generates the triangle ID information for said texture space to be used both for the texture access and the object-space shading.

In an implementation form, the rendering apparatus 202 includes a processor 204 and a memory 206. In an implementation form, the processor 204 of the rendering apparatus 202 is configured for the above-described geometry processing for the object-space shading by executing certain instructions, while the memory 206 is used to store the instructions to be executed by the processor 204. The processor 204 may refer to one or more individual processors, processing devices, and various elements associated with a processing device that may be shared by other processing devices. Additionally, the one or more individual controllers, processors, processing devices, and elements can be arranged in various architectures for implementing the above-described geometry processing. In some implementations, the processor 204 may be an independent unit and may be located outside the rendering apparatus 202. Examples of the processor 204 may include, but are not limited to, a hardware processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other control circuitry. The processor 204 is communicatively connected with the memory 206 by any proper means.

The memory 206 is configured to store the instructions executable by the processor 204 as well as all data and information related to the object-space shading including the UV coordinate data, the UV layers, and etc. Examples of the memory 206 may include, but are not limited to, an Electrically Erasable Programmable Read-Only Memory (EEPROM), Random Access Memory (RAM), GPU RAM or video RAM (VRAM), Read-Only Memory (ROM), Hard Disk Drive (HDD), Flash memory, Solid-State Drive (SSD), persistent memory, remote direct memory access (RDMA), a Central Processing Unit (CPU) cache memory and a GPU cache memory.

The rendering apparatus 202 provides an efficient solution for building an object-space shading framework and is characterized by all the benefits and advantages of the method 100 described above.

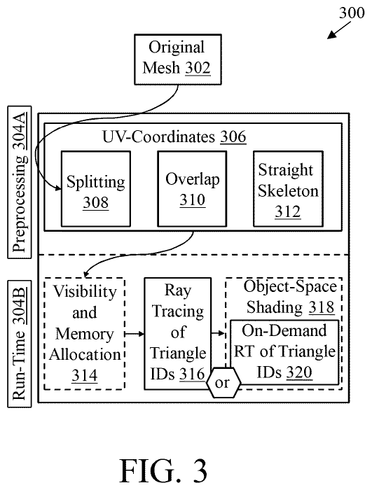

FIG. 3 is a diagram that schematically depicts an object-space shading framework including the geometry processing in accordance with embodiments of the present disclosure. FIG. 3 is described in conjunction with elements from FIGS. 2 and 1. With reference to FIG. 3 there is shown a diagram that schematically depicts the object-space shading framework 300, which for example can be implemented by the rendering apparatus 202 of FIG. 2 and includes the geometry processing in accordance with embodiments of the present disclosure, namely, different embodiments and implementation forms of the method 100 of FIG. 1.

With reference to FIG. 3, there is shown steps and operations that can be used for shading an artist-provided object in the form of incoming mesh data, for example, an original mesh 302, in accordance with embodiments of the present disclosure, namely, different embodiments and implementation forms of the method 100. The object-shading framework 300 consist of two steps or stages—the pre-processing stage 304A and the run-time stage 304B. At the pre-processing stage 304A, instead of generating additional UV-channels, the object-space shading framework 300 provides for adapting the artist provided UV-coordinates 306, even supporting overlaps and out-of-bounds coordinates, into UV layers in accordance with embodiments of the present disclosure by means of operations 308 to 312. With the operation 308, all triangles of the original mesh 302 with one or more UV coordinates outside the 0-1 range are split into smaller triangles with coordinates within the 0-1 range that are assigned to as few different UV layers as possible. In an implementation form, the operation 308 comprises splitting each triangle with coordinates that differ in an integer component into smaller triangles along axis-aligned lines at integer intervals of the coordinates so that all the split triangles have a uniform integer component, and setting all non-zero integer components of the coordinates of the split triangles to zero. Then, in the operation 310, any overlapping triangles of the original mesh 302 are processed by splitting them into different UV layers, so that all the split triangles are assigned to as few UV layers as possible. In an implementation form, the splitting of overlapping triangles into different UV layers comprises: defining one or more islands of triangles, wherein each island comprises neighbouring triangles that share one or more UV vertices, splitting islands into unit islands along axis-aligned lines at integer intervals of the coordinates, splitting each unit island that comprises overlapping triangles into as few islands without overlapping triangles as possible, and splitting overlapping islands into as few groups of islands without overlaps as possible, wherein each group of islands without overlaps is assigned to a different UV layer. In further implementation form, the splitting of each unit island that comprises overlapping triangles into as few islands without overlapping triangles as possible and the splitting of overlapping islands into as few groups of islands without overlaps as possible comprise solving a graph colouring problem approximately with a greedy algorithm.

In addition, the pre-processing stage 304A of the object-space shading workframe 300 ends with the operation 312 of building a straight skeleton to fill empty areas in the UV layers for efficient border handling in accordance with corresponding embodiment of the present disclosure. The operation 312 is applied instead of tackling border issues by filtering already rendered pixels in the prior art solutions, and it makes the object-space shading framework 300 resolution independent in combination with the ray tracing which is applied in further operation 316 or 320. In an implementation form, the assigning of empty areas comprises building a straight skeleton in each UV layer by means of: determining borders of the 0-1 range as non-moving edges, building the straight skeleton by moving outer edges of a polygon composed of the triangles located in the UV layer, generating additional triangles by triangulating areas swept by the moving edges, and assigning each of the additional triangles to that triangle whose moving edge was swept over corresponding area.

Thereafter, the object-space shading framework 300 continues with operations 314 to 320 to be performed during the run-time stage 304B of the shading procedure. At that, the operation 314 of determining a visibility and memory allocation for the shading procedure is equivalent to similar operations of the conventional texture-space shading solutions and can be performed by known means and techniques. The distinguishing aspect of the object-space shading framework 300 relates to ray tracing of triangles IDs in the operation 316 or the alternative operation 320, after determining the visibility and performing any necessary memory allocation tasks, to get the required triangle ID information for the subsequent or running object-space shading of the operation 318. Thereby, the object-space shading framework 300 of FIG. 3 provides for two alternatives of how and when the ray tracing of the triangle IDs is performed shown by the alternative operations 316 and 320. In case of realizing the object-space shading pipeline with performing the operation 316, the ray tracing of triangle IDs is conducted during the run-time for a limited number of sample points in the UV layers that have been determined as visible in the operation 314. In the alternative, when the object-space shading pipeline is realized with the operation 320, the ray tracing of triangle IDs is conducted on-demand, during the run-time of the object-space shading operation 318 for a limited number of sample points in the UV layers obtained in result of the operations 308 to 312, when it is required for computing shading or various graphics effects in the texture space of the object.

In an implementation form, the rendering apparatus 202 described above with reference to FIG. 2 is configured to perform all the operations of the object-space shading workframe 300. The object-space shading workframe 300 thereby provides an efficient solution for performing object-space shading tasks in rendering systems which is characterized by all the benefits and advantages of the method 100 described above.

FIG. 4 is a diagram that schematically depicts a scenario of UV space adaptation, in accordance with embodiments of the present disclosure. FIG. 4 is described in conjunction with elements from FIGS. 1 to 3. With reference to FIG. 4, there is shown a diagram 400 that schematically depicts how an artist-provided geometry, such as a part of the original mesh 302, is adapted by splitting into UV layers in accordance with embodiments of the present disclosure such as implementation forms of the step 102 of the method 100 described with reference to FIG. 1.

With reference to FIG. 4, there are schematically shown incoming UV-coordinates 402 being a part of an artist-provided mesh, which do not adhere to set criteria of the object-space shading and are to be processed for subsequent shading. In accordance with embodiments of the present disclosure the incoming UV-coordinates 402 are split into UV-layers so that each UV layer comprises non-overlapping triangles with coordinates within a 0-1 range shown in FIG. 4 by UV layers 404, 406 and 408. In order to get the UV layers 404, 406 and 408 with non-overlapping triangles within the 0-1 range, the operations 308 and 310 of the object-space shading framework 300 are performed as described with reference to FIG. 3 or the step 102 of the method 100 is implemented as described with reference to FIG. 1.

In an implementation form, at first triangles of the incoming UV-coordinates 402 with coordinates outside the 0-1 range are considered, and triangles that cross over an integer border are split into smaller triangles assigned to different UV layers as follows: the integer and decimal components of the UV-coordinates are considered separately and any triangles with UV-coordinates that differ in the integer part are subdivided along axis-aligned lines at integer intervals, so that all the split triangles have a uniform integer component. All non-zero integer components of the split triangles are then set to zero to bring the coordinates into the 0-1 range. In the example illustrated in FIG. 4 there is one triangle 402A extending outside the 0-1 range in the incoming UV-coordinates 402. In result of the above-described adaptation, the out-of-bounds triangle 402A is split into three smaller triangles assigned to two UV layers: a smaller triangle 404A in the first UV layer 404 and two smaller triangles 406A and 406B in the second UV layer 406. Such adaptation still results in the same sampling of the texture, if the sampling address mode is repeating. In a case of other sampling address modes, such as mirrored repeating, the split procedure can be trivially adapted.

Further processing is intended for addressing the issue of overlapping triangles. In order to resolve the overlaps, they are separated into different UV layers as per corresponding embodiments of the present disclosure. In an implementation form, for this end islands are determined, which are connected components in the processed triangles, i.e. each island comprises neighbouring triangles that share the same UV-vertices. The islands, which have internally overlapping triangles, are split into as few non-overlapping islands as possible. The resulting islands are then assigned to as few UV layers as possible within which the triangles do not overlap. In the example illustrated in FIG. 4 there is one island 402B with internally overlapping triangles in the incoming UV-coordinates 402. In result of the above-described adaptation, the island 402B is split into islands 404B and 408A with no overlaps in two UV layers 404 and 408.

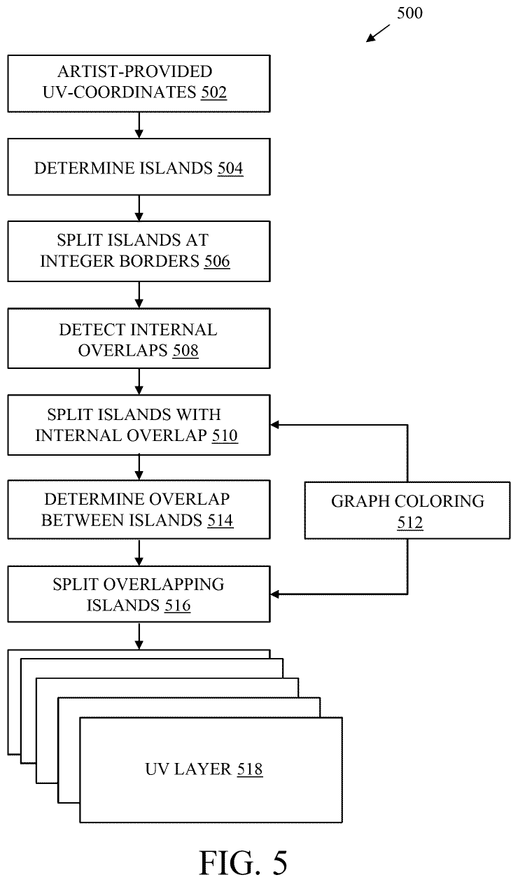

The UV coordinate data adaptation as described and shown in FIG. 4 ensures that the least amount of space and thus memory is used for the UV layers, while at the same time there is not unnecessarily splitting of islands. This increases the performance as any unnecessary splitting of islands would introduce additional borders, which then would increase an overhead when handling the borders. An algorithm of geometry processing for generating UV layers is described in more details below with reference to FIG. 5.

FIG. 5 is a diagram that depicts a flowchart of a method of geometry processing for generating UV layers that can be implemented by a rendering apparatus, in accordance with an embodiment of the present disclosure. FIG. 5 is described in conjunction with elements from FIGS. 1 to 4. With reference to FIG. 5, there is shown a diagram that depicts a flowchart of a method 500 of geometry processing for generating the UV layers that can be implemented by the rendering apparatus 202 of FIG. 2.

In an implementation form, the method 500 of geometry processing for generating the UV layers includes steps 502 to 518. At step 502, artist-provided UV coordinates, such as the original mesh 302, are obtained, for example, by the rendering apparatus 202 of FIG. 2, for further adaptation with splitting it into UV layers in accordance with embodiments of the present disclosure. Thereafter, at step 504, islands consisting of triangles with shared UV vertices are determined in the artist-provided UV coordinates. Furthermore, at step 506, the islands are split along axis-aligned lines at integer intervals or borders, i.e. the processing equivalent to the operation 308 of the object-space shading framework 300 described with refence to FIG. 3 is performed. In addition, at step 508 of detecting internal overlaps determined are islands that have internal overlaps, i.e. have triangles overlapping with other triangles of the same island. Thereby, this step is similar to the operation 310 of the object-space shading framework 300 described with refence to FIG. 3. After that, at step 510, the determined islands with internal overlaps are split into as few islands without internal overlaps as possible. At that, for minimizing the number of split islands without internal overlaps, one should solve an NP-hard graph colouring problem as shown by the step 512, which for example can be solved approximately with various greedy algorithms. Moreover, at step 514, overlaps between the islands obtained after the step 510 are determined, and at step 516, the determined overlapping islands are split into as few UV layers 518 as possible, wherein each UV layer consists of non-overlapping triangles with coordinates within the 0-1 range. In order to minimize the number of the UV layers 518 in the step 516, one should solve an NP-hard graph colouring problem as shown by the step 512, which for example can be solved approximately with various greedy algorithms.

The method 500 is a part of embodiments of the method 100 described with reference to FIG. 1 and it is shown separately to disclose an implementation form of the splitting of the artist-provided UV coordinates into UV layers in more details.

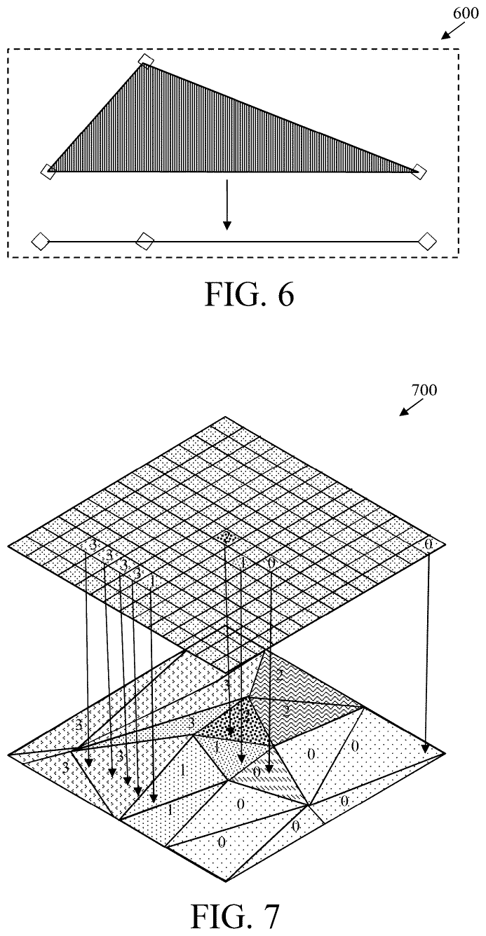

FIG. 6 is a diagram that depicts a special case of degenerate triangle that can be handled during the geometry processing in accordance with an embodiment of the present disclosure, for example, during the geometry processing described above with refence to FIG. 5.

With reference to FIG. 6, there is shown a degenerate triangle, i.e. the triangle having colinear vertices and thus zero area at certain viewing direction. Beneficially, such degenerate triangles do not need any special treatment within the UV-space adaption in accordance with different embodiments of the present disclosure. Indeed, the degenerate triangles can be ignored during the texture processing of the present disclosure since they do not cover any area in the texture-space. Another special case to consider relates to presence of huge triangles within the UV coordinates. Such triangles are sometimes encountered within artist-provided models that usually have single-color textures. Such huge triangles would be split into many smaller triangles during the adaptation as per the present disclosure, such as the processing of the step 102, the operation 308 or the step 506 described above, unnecessarily leading to greater memory consumption, lower performance, and possible occurrence of artefacts. To address this issue a new UV-space can be generated for such models automatically, overwriting the faulty UV coordinates provided by the artist, and then the same adaptation as per embodiments of the present disclosure can be applied to the new UV-space. Alternatively, the artist can be requested to resolve the issue by correcting the faulty UV-coordinates of the model with huge triangles.

FIG. 7 is a diagram that depicts a two-dimensional ray tracing of triangle IDs during the geometry processing in accordance with an embodiment of the present disclosure. FIG. 7 is described in conjunction with elements from FIGS. 1, 3 and 5. With reference to FIG. 7 there is shown a diagram 700 that depicts an exemplary two-dimensional ray tracing of triangle IDs.

In different embodiments and implementation forms of the present disclosure, the ray tracing of triangle IDs, or triangle ID rendering, is performed during the run-time of the object-space shading to access to triangle ID information as it is described above, for example, with reference to FIGS. 1 to 3. Beneficially, as compared to the conventional shading solutions, an image-order algorithm like the ray tracing is better suited for the triangle ID rendering. Further advantage of the present disclosure consists in possibility to perform a simplified, two-dimensional ray tracing, turning a three-dimensional ray into a two-dimensional point, as it is illustrated in FIG. 7. This is enabled by the efficient pre-processing of the artist-provided UV coordinate data with adaptation it into the UV layers of non-overlapping triangles within the 0-1 range in accordance with embodiments and implementation forms of the present disclosure, such as the processing of the step 102, the operation 308 or the step 506 described above with reference to FIGS. 1, 3 and 5. Furthermore, no ray marching is required in such ray tracing, since there is no ray, but a single point that is sampled, and no overlap resolution or ordering of triangles is required as only a single triangle can lie at a certain position in the UV layers without overlaps obtained after the adaptation of the artist-provided UV coordinate data in different embodiments and implementation forms of the present disclosure. Thus, the two-dimensional ray tracing computations in embodiments of the present disclosure can be further optimized for an increased performance by utilizing specialized hardware and/or software (as conventional GPUs usually support only three-dimensional ray tracing computations).

FIG. 8 is a diagram that depicts a quad-tree-based acceleration structure as used during the geometry processing in accordance with an embodiment of the present disclosure. FIG. 8 is described in conjunction with elements from FIG. 7. With reference to FIG. 8, there is shown a diagram 800 that depicts an exemplary quad-tree based acceleration structure that can be used in the geometry processing as per the present disclosure.

Known are various options of tree-based acceleration structures used in the ray-tracing such as the bounding volume hierarchy (BVH), that can be used in embodiments of the present disclosure. As an example, FIG. 8 illustrates a quad tree-based acceleration structure that can be used for achieving an enhanced performance in the two-dimensional ray tracing of triangle IDs according to an embodiment of the present disclosure, for example, as shown in FIG. 7. Since the triangle IDs are usually computed for pixel blocks with a power of two resolutions, the use of the quad tree-based acceleration structure, such as shown in FIG. 8, leads to ideal coherence between the sample locations within such a block allowing optimal utilization of parallelized hardware.

FIG. 9 is a diagram that depicts an exemplary implementation of a straight skeleton building to assign empty areas at borders of an object geometry in a UV layer to triangles located therein in accordance with an embodiment of the present disclosure. FIG. 9 is described in conjunction with elements from FIG. 8. With reference to FIG. 9, there is shown a diagram 900 that depicts an exemplary building of the straight skeleton to assign empty areas at borders of the object geometry in a UV layer that consists of three triangles (‘1’, ‘2’ and ‘3’) to said triangles.

With reference to FIG. 9, there is shown an exemplary UV layer with three triangles (numbered ‘0’, ‘1’, ‘2’ in the figure for clarity) of the same geometry as shown in FIG. 8. As explained above the building of the straight skeleton in embodiments of the present disclosure is required for assigning empty areas between the borders of a polygon composed of the three triangles located in the UV layer and the borders of the UV layer being the 0-1 range borders. In an embodiment, an improved straight skeleton building algorithm of Aichholzer and Aurenhammer is used for this end. The improved algorithm is configured for: determining borders of the 0-1 range of the UV layer as non-moving edges, building the straight skeleton by moving outer edges of the polygon composed of the triangles located in the UV layer, generating additional triangles by triangulating areas swept by the moving edges, and assigning each of the additional triangles to that triangle whose moving edge was swept over corresponding area. The moving edges of the three triangles and their directions of moving are shown in FIG. 9 with arrows, the three original triangles are filled and numbered as ‘0’, ‘l’ and ‘2’, while additional triangles obtained in result of the triangulation are marked with different fillings but so that to clarify to what original triangle they are assigned. Subsequently, during the ray-tracing of triangle IDs, a simple mapping from the ray-traced triangle to the original triangle can be used. Beneficially, this approach provides for an improved border handling at any resolution without having to run any filtering. Moreover, this aspect of the disclosure can be used even together with rasterized triangle IDs.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A method of geometry processing for an object-space shading, the method comprising:
splitting UV coordinate data of an object to be shaded into UV layers so that each UV layer comprises non-overlapping triangles with coordinates within a 0-1 range, and
generating triangle index, ID, information for the UV layers to be used for the object-space shading.

2. The method of claim 1, wherein the splitting UV coordinate data of an object to be shaded into UV layers comprises:
splitting each triangle with one or more coordinates outside the 0-1 range from the UV coordinate data into smaller triangles with coordinates within the 0-1 range assigned to different UV layers, and
splitting overlapping triangles into different UV layers,
wherein the split triangles are assigned to as few UV layers as possible.

3. The method of claim 2, wherein the splitting each triangle with one or more coordinates outside the 0-1 range from the UV coordinate data into smaller triangles comprises:
splitting the triangle with coordinates that differ in an integer component into smaller triangles along axis-aligned lines at integer intervals of the coordinates so that all the split triangles have a uniform integer component, and
setting all non-zero integer components of the coordinates of the split triangles to zero.

4. The method of claim 2, wherein the splitting overlapping triangles into different UV layers comprises:
defining one or more islands of triangles, wherein each island comprises neighbouring triangles that share one or more UV vertices,
splitting islands into unit islands along axis-aligned lines at integer intervals of the coordinates,
splitting each unit island that comprises overlapping triangles into as few islands without overlapping triangles as possible, and
splitting overlapping islands into as few groups of islands without overlaps as possible, wherein each group of islands without overlaps is assigned to a different UV layer.

5. The method of claim 4, wherein the splitting each unit island that comprises overlapping triangles into as few islands without overlapping triangles as possible and the splitting overlapping islands into as few groups of islands without overlaps as possible comprise solving a graph colouring problem approximately with a greedy algorithm.

6. The method of claim 1, wherein the generating triangle ID information for the UV layers comprises two-dimensional ray tracing of triangle indices, IDs, for sample points in the UV layers.

7. The method of claim 6, wherein the two-dimensional ray tracing of triangle IDs comprises using a quad tree-based acceleration structure.

8. The method of claim 1, further comprising assigning empty areas at borders of the object geometry in the UV layers to triangles located therein.

9. The method of claim 8, wherein the assigning empty areas comprises building a straight skeleton in each UV layer by:
determining borders of the 0-1 range as non-moving edges,
building the straight skeleton by moving outer edges of a polygon composed of the triangles located in the UV layer,
generating additional triangles by triangulating areas swept by the moving edges, and
assigning each of the additional triangles to that triangle whose moving edge was swept over a corresponding area.

10. The method of claim 1, wherein the generating triangle ID information for the UV layers comprises three-dimensional ray tracing of triangle indices, IDs, for sample points in the UV layers,
the method further comprises assigning empty areas at borders of the object geometry in the UV layers to triangles located therein by building simple skirts in each UV layer by extending three-dimensional skirts as wavefronts from outer edges of a polygon composed of the triangles located in the UV layer.

11. The method of claim 6, wherein the ray tracing of triangle IDs is conducted during a pre-processing stage of the object-space shading for all the sample points in the UV layers and the method further comprises:
mapping the ray-traced triangle IDs into textures with a multum in parvo, MIP, hierarchy, and
storing the textures into a storage medium for loading during a run-time of the object-space shading.

12. The method of claim 6, wherein the ray tracing of triangle IDs is conducted during a run-time of the object-space shading for a limited number of sample points in the UV layers that have been determined as visible.

13. The method of claim 6, wherein the ray tracing of triangle IDs is conducted during a run-time of the object-space shading for a limited number of sample points in the UV layers, when it is required for computing graphics effects in a texture space of the object.

14. A rendering apparatus comprising a processor configured for geometry processing for an object-space shading by:
splitting UV coordinate data of an object to be shaded into UV layers so that each UV layer comprises non-overlapping triangles with coordinates within a 0-1 range, and
generating triangle index, ID, information for the UV layers to be used for the object-space shading.
